(19) United States
(12) Patent Application Publication
(10) Pub. No.: US 2005/0061358 A1
(43) Pub. Date: Mar. 24, 2005

(54) Machine for washing carts and bins

(76) Inventors: Robert Fenautrigues, Letra (FR); Alain Guerpillon, Limas (FR); Noel Mathieu, Gleize (FR)

Correspondence Address: RATNERPRESTIA, P O BOX 980, VALLEY FORGE, PA, 19482-0980, US

(21) Appl. No.: 10/943,419

(22) Filed: Sep. 17, 2004

(30) Foreign Application Priority Data
Sep. 18, 2003 (FR) 03 11094

(51) Int. Cl. B08B 3/00

(52) U.S. Cl. 134/30; 134/123

(57) ABSTRACT

A washing machine is disclosed that comprises an enclosure for receiving a cart to be washed. A main shuttle assembly is movable vertically on vertical guides and carries a fan for passing drying air over a heater and projecting it from a slot toward the cart in the form of a flat horizontal jet of air. The main shuttle assembly also carries washing manifolds, opposite second washing manifolds carried by a secondary shuttle assembly that is itself mobile vertically. The shuttle assemblies are driven by pulleys at the top. The washing enclosure is associated with a dehumidifier center located above its ceiling for drying the air inside the washing enclosure during drying steps. Carts are therefore dried faster and leave at a lower temperature allowing their immediate manipulation.

### TECHNICAL FIELD OF THE INVENTION

The present invention relates to apparatus and installations for washing laundry or hospital carts or large bins necessitating satisfactory disinfection.

Laundry and hospital carts and mobile bins are used inside buildings to transport diverse objects such as bedlinen, meal trays and medication.

The objects transported generally contain germs that tend to be deposited on the carts or mobile bins, which may then grow and/or propagate to other objects subsequently transported by the same carts. This results in a risk of propagation of infection by bacteria or mold.

It is therefore necessary to wash laundry and hospital carts and mobile bins periodically to minimize the risk of propagating infection.

There have already been proposed machines for washing carts and mobile bins comprising a closed washing enclosure having at least one closeable access door for entry and exit of at least one cart or mobile bin to be washed. The enclosure comprises washing manifolds mobile horizontally or vertically along at least one side of the washing enclosure to spray a washing liquid toward the cart(s) or bin(s) with a sweeping movement.

A washing cycle is generally followed by hot air drying, in which heated air is caused to circulate in the enclosure.

In the prior art machines, to achieve an acceptable throughput, i.e. sufficiently fast drying to take out a dry cart and introduce the next cart, the drying air, and therefore the cart or mobile bin, must be heated to a relatively high temperature that evaporates water on the surface of the cart or the bin and in the interstices thereof faster. However, the cart or mobile bin is then very hot at the end of the drying cycle, for example at a temperature greater than 60° C., and it is therefore necessary to wait for it to cool to be able to handle it to take it out of the enclosure and move it toward its point of use. This waiting time further increases the duration of the cart or mobile bin processing cycle.

### SUMMARY OF THE INVENTION

The problem addressed by the present invention is that of designing a new structure for machines for washing carts and mobile bins that ensures perfect drying in a reduced cycle time, thereby increasing washing throughput.

A particular object of the invention is to ensure very efficient drying in the interstices of the carts or mobile bins to be washed in order to prevent growth of germs and mold therein caused by the presence of moisture.

The invention aims to ensure very efficient drying without unduly increasing the temperature of the cart or mobile bin at the end of the drying cycle, in order to allow handling of the cart or mobile bin immediately after drying finishes.

To achieve the above and other objects, the invention proposes a machine for washing carts and bins, the machine comprising a closed washing enclosure having at least one front access passage with closure means for the entry and exit of at least one cart or bin to be washed, with washing manifolds mobile along at least one side of the washing enclosure to spray a washing liquid toward the cart(s) or bin(s) with a sweeping movement, and with means for producing and projecting toward the cart(s) or bin(s) hot drying air; according to the invention:
means for producing and projecting the hot drying air comprise a main shuttle assembly movable vertically in the vicinity of a wall of the washing enclosure, comprising first ventilation means for aspirating air from said wall, to circulate it over heating elements in order to heat it, and for propelling it into appropriate guide ducts that project it in the form of a unidirectional flat jet of air into the washing enclosure, so that the unidirectional flat jet of air mechanically expels droplets of liquid present on the cart(s) or bin(s) during drying steps,
the machine further comprises a dehumidifier center adapted to aspirate air from the washing enclosure, to dry the aspirated air, to heat it, and to return it into the washing enclosure in an independent flow during the drying steps.

Thanks to the combination of efficient mechanical expulsion of droplets followed by dehumidification of the ambient air in the enclosure, drying is particularly fast and efficient, and the risk of moisture stagnating in the interstices of a cart or mobile bin to be washed is eliminated.

Dehumidification also enables rapid drying without heating the drying air unduly.

The heating elements of the main shuttle assembly preferably heat the drying air to a temperature from approximately 40° C. to approximately 50° C., and advantageously of the order of 45° C. It is then possible to take hold of the cart as soon as drying is completed, without waiting for it to cool.

In one advantageous embodiment, the main shuttle assembly is disposed along a lateral wall of the washing enclosure and furthermore carries one or more washing manifolds adapted to spray jets of washing liquid transversely into the washing enclosure below ducts for producing the transverse unidirectional flat jet of air.

More efficient washing is obtained by providing a secondary shuttle assembly opposite the main shuttle assembly, movable vertically in front of the main shuttle assembly, and carrying one or more washing manifolds.

The dehumidifier center may advantageously comprise second ventilation means for selectively aspirating air from the washing enclosure and passing it through an evaporator that cools the air and condenses its moisture, then through a condenser and through a heat exchanger that heat the air, and then returning it into the washing enclosure.

The dehumidifier center preferably comprises an inlet flap which, in a first washing position, selectively directs air extracted from the washing enclosure toward the outside atmosphere during washing steps and, in a second drying position, selectively directs air extracted from the washing enclosure to recycle it to the washing enclosure after passing it through the evaporator, the condenser and the heat exchanger during drying steps.

During washing steps, the inlet flap in the first washing position takes in outside air to direct it into the washing enclosure via the evaporator, the condenser and the heat exchanger, which is inactive during washing steps.

In one advantageous embodiment the main shuttle assembly and the secondary shuttle assembly are each driven in vertical movement by a respective pulley and a respective traction cable, with a traction cable tension sensor supplying an alarm signal to interrupt the rotation of the pulley in the event of detection of a tension above a particular top threshold or below a particular bottom threshold.

Another aspect of the invention consists in a method of washing carts and bins using the above washing machine, the method comprising the following steps:
a) a washing step during which the washing manifolds are fed with washing liquid and the main shuttle assembly and the secondary shuttle assembly are moved vertically to spray jets of washing liquid onto a cart or mobile bin placed in the enclosure during one or more sweeps,
b) a rinsing step, similar to the washing step, but using a rinsing liquid, and
c) a drying step, during which the cart or mobile bin is swept with a unidirectional transverse flat jet of air which mechanically expels droplets of rinsing liquid present on the cart or mobile bin, and the air in the enclosure is dried by the dehumidifier center, the temperature of the drying air in the transverse flat jet of air being from approximately 40° C. to approximately 50° C.

### BRIEF DESCRIPTION OF THE DRAWINGS

Other objects, features and advantages of the present invention will emerge from the following description of a particular embodiment, which is given with reference to the appended drawings:

FIG. 1 is a general front view of one embodiment of a washing machine of the present invention;

FIG. 2 is a diagrammatic perspective view showing a drying and spraying shuttle assembly of the FIG. 1 machine;

FIG. 3 is a functional schematic showing drive means of the FIG. 1 shuttle assembly;

FIG. 4 is a diagrammatic side view showing the FIG. 1 machine with its dehumidifier center during washing;

FIG. 5 shows the FIG. 4 washing machine during drying; and

FIG. 6 shows diagrammatically the operation of means for shutting off an access passage.

### DESCRIPTION OF THE PREFERRED EMBODIMENTS

In the embodiment shown in the figures, the machine of the invention for washing carts and bins comprising a closed washing enclosure 1, of generally parallelepiped shape, delimited by two lateral faces 2 and 3, a rear front face 4, an anterior front face opposite the rear front face 4, a floor 5 and a ceiling 6. The floor 5 may be a watertight wall attached to the lateral faces 2 and 3. Alternatively, and more simply, the floor 5 may be the floor of the building, previously provided with a standpipe and a waste water drain. The anterior front face opposite the back front face 4 comprises a closable access passage for the entry and exit of at least one cart 7 or mobile bin to be washed. The cart 7 is mounted on castors such as the castors 8 and 9.

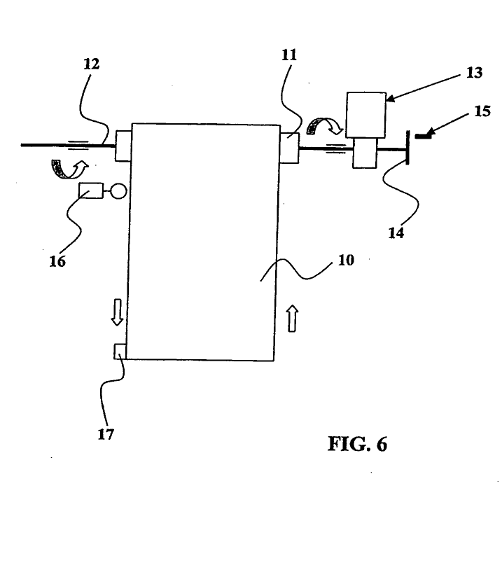

For example, the anterior front face may be closed by a roller shutter 10 as shown in FIG. 6, the roller shutter may be wound onto a drum 11 rotating on a transverse shaft 12 driven by a gearmotor 13 and whose angular position is indicated by a disk 14 keyed to the shaft 12 and associated with an optical sensor 15.

The gearmotor 13 is equipped with an integral torque limiter.

A top position sensor 16 limits upward travel of the roller shutter 10. A bottom position sensor 17 limits downward travel of the roller shutter 10.

Washing manifolds 18, 19, 20 and 21 mobile along the lateral walls 2 and 3 are mounted on either side of the enclosure 1. The washing manifolds 18 to 21 are oriented horizontally along respective lateral faces 2 and 3, and are conformed to direct a plurality of jets of washing liquid toward the opposite lateral face 3 or 2, i.e. toward the center of the enclosure 1.

The first two washing manifolds 18 and 19 are carried by a main shaft 22, movable vertically in the vicinity of the first lateral wall 2 of the enclosure 1. The main shuttle assembly 22 is guided in its vertical movement along vertical guides 23 attached to the walls of the enclosure 1, and is driven by a first traction cable 24 driven by a first top pulley 25.

The other two washing manifolds 20 and 21 are carried by a secondary shuttle assembly 26 movable vertically along second vertical guides 27 and is driven by a second traction cable 28 driven by a second top pulley 29.

The main shuttle assembly 22 takes the form of a box, with a lateral air inlet 22c facing the lateral wall 2, and an air outlet slot 22e on the opposite face.

The main shuttle assembly 22 contains first ventilation means 22a, consisting of an axial inlet, radial outlet fan, driven by an electric motor 22b. The fan 22a aspirates air through the axial inlet 22c in the vicinity of the lateral wall 2, and discharges air through a radial passage 22d toward a lower compartment of the box provided with the lateral outlet slot 22e at the end of a progressively tapering dihedral region 22f. The resulting box forms an appropriate guide duct. A heater element 22g is disposed downstream of the fan 22a, for example. As a result, by virtue of rotation of the motor 22b and the fan 22a, the main shuttle assembly 22 produces a flat horizontal jet of hot air directed toward the opposite lateral wall 3, i.e. toward the center of the enclosure 1. The unidirectional flat jet of hot air leaving the main shuttle assembly 22 mechanically expels droplets of liquid from the cart 7 or mobile bin during drying steps.

The enclosure 1 is associated with a dehumidifier center 30, adapted to aspirate air from the enclosure 1, to dry the aspirated air, to heat it, and to return it to the enclosure 1 in the form of a flow independent of the flow of air produced by the main shuttle assembly 22 during drying steps.

The power of the heater elements 22g of the main shuttle assembly is chosen so that, during drying steps, they heat the air to a temperature from approximately 40° C. to approximately 50° C.

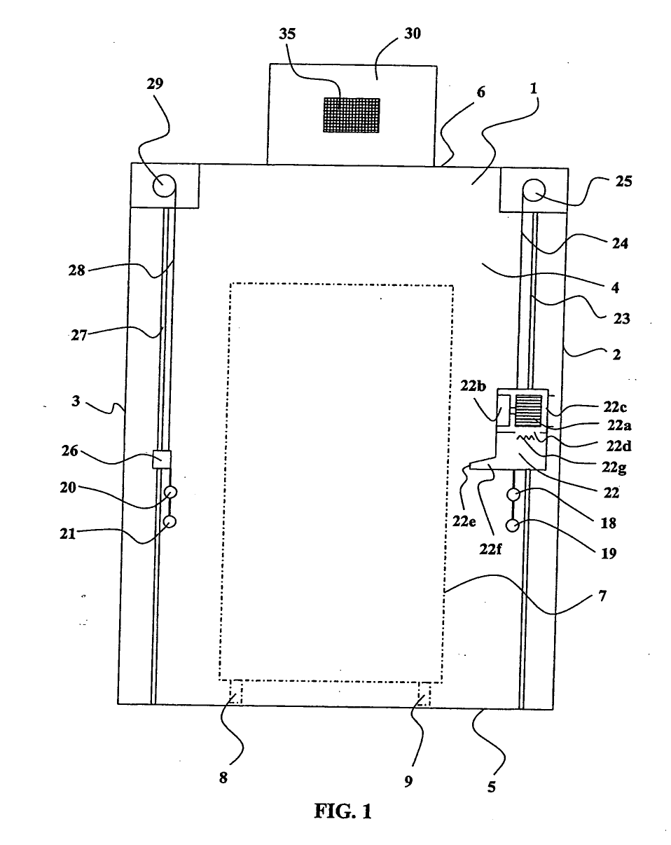

As seen in FIG. 1, the washing manifolds 18 and 19 are disposed below the air outlet 22e. As a result, the washing manifolds 18 and 19 spray jets of washing liquid transversely into the enclosure 1 below the means producing the flat jet of air.

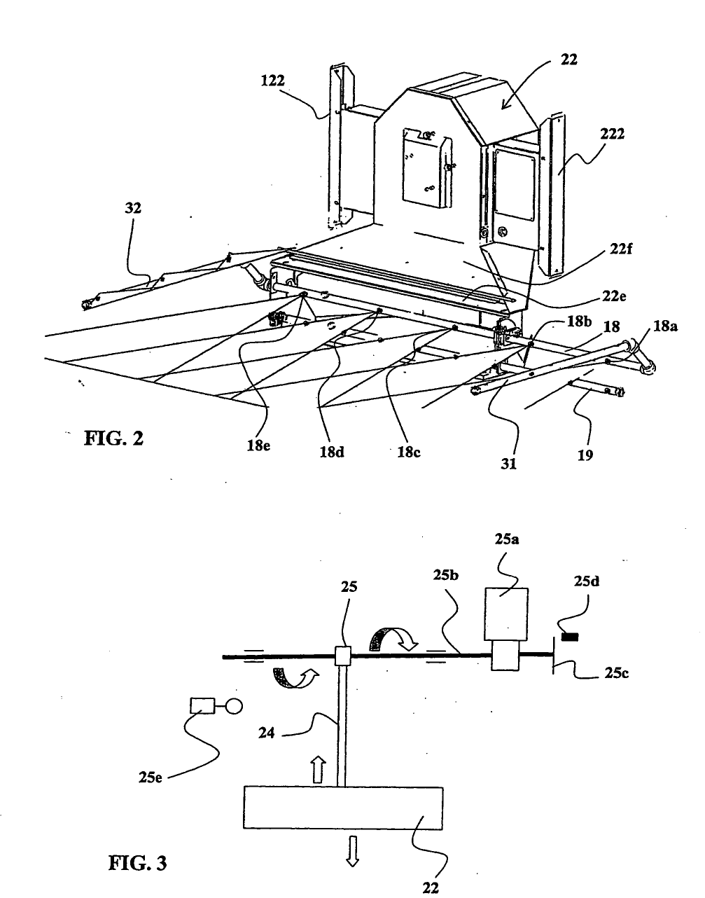

FIG. 2 shows again the shuttle assembly 22 with two lateral bearings 122 and 222 conformed to slide along vertical guides like the first vertical guide 23 from FIG. 1, thereby ensuring a constant orientation of the main shuttle assembly 22. Also shown again are the tapering region 22f and the air outlet 22e.

Further shown again are the two washing manifolds 18 and 19 which comprise respective spray nozzles like the nozzles 18a, 18b, 18c, 18d, 18e on the manifold 18, distributed along their length. Each nozzle 18a-18e produces a jet of washing liquid, during washing steps, as shown in the figure.

In the embodiment shown, the top washing manifold 18 is associated with two horizontal transverse washing manifolds 31 and 32 in the vicinity of the access passage and in the vicinity of the opposite rear front face 4 of the enclosure 1, respectively. To prevent all risk of impact or of destructive pressure of a transverse manifold 31 or 32 on a cart during the vertical sweeping movement of the shuttle assembly 22, the transverse washing manifolds 31 and 32 are free to pivot upward, by rotating about the axis of the manifold 18, which is rotatably mounted on the shuttle assembly 22. Thanks to this possibility of rotation, the transverse manifolds 31 or 32 may remain abutted against an obstacle during downward movement of the main shuttle assembly 22, without risk of serious damage. Furthermore, a position sensor may detect rotation of the transverse washing manifolds 31 and 32 if there is an obstacle, and then interrupt operation of the first top pulley 25 to stop the movement of the main shuttle assembly 22.

The first top pulley 25 and the second top pulley 29 are preferably associated with corresponding cable tension sensors 24 or 28 that supply an alarm signal to interrupt rotation of the pulley 25 or 29 if a tension is detected above a particular top threshold or below a particular bottom threshold. As a result, when the main shuttle assembly 22, or the secondary shuttle assembly 26, or the associated washing manifolds 18-21 encounter an obstacle during vertical downward movement, the cable tension sensor detects a cable tension below a particular bottom threshold corresponding to the weight of the corresponding shuttle assembly and its load, and this leads to the generation of an alarm signal and the stopping of the corresponding pulley 25 or 29.

Similarly, when the main shuttle assembly 22, or the secondary shuttle assembly 26 or the corresponding washing manifolds 18-21 encounter an obstacle during vertical movement in upward translation, the cable tension sensor detects a cable tension above the particular top threshold, and causes the corresponding pulley 25 or 29 to be stopped.

Refer now to FIG. 3, which shows diagrammatically the means for driving the main shuttle assembly 22. There is shown again the first cable 24, driven by the pulley 25 which is in turn driven by a gearmotor 25a and a shaft 25b, with a counting disk 25c keyed to the shaft 25b, and a detector cell 25d for indicating the angular position of the shuttle assembly. A top position sensor 25e limits upward travel of the main shuttle assembly 22.

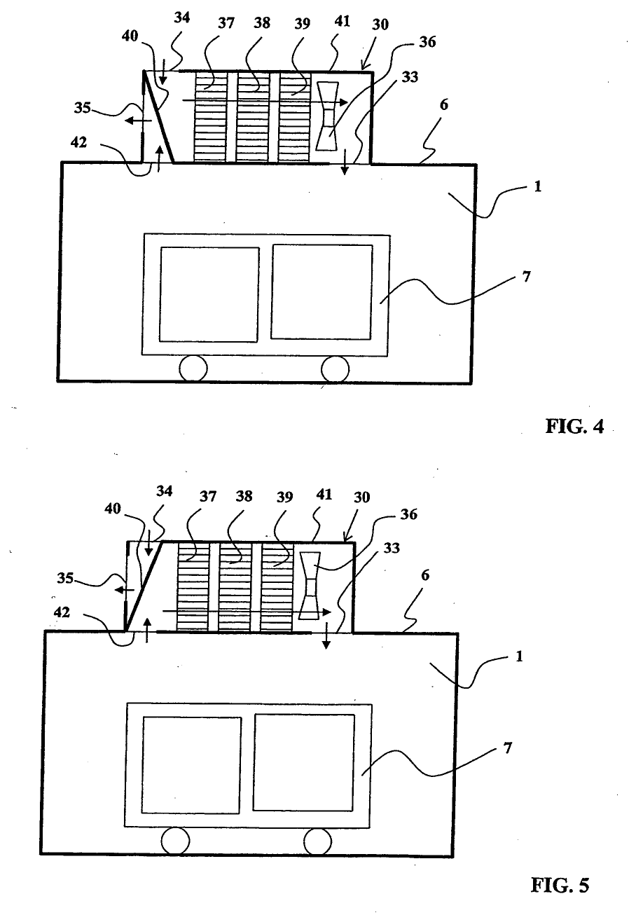

Refer now to FIGS. 4 and 5, showing diagrammatically the structure of the dehumidifier center 30.

The dehumidifier center 30 is advantageously placed in an upper position above the enclosure 1, for example above the ceiling 6.

The dehumidifier center 30 is contained in a box 41 which communicates with the enclosure 1 via an air inlet 42 and an air outlet 33.

The box 41 further communicates with the external atmosphere via a main inlet 34 and a main outlet 35.

The dehumidifier center essentially comprises second ventilator means 36, an evaporator 37, a condenser 38 and a heat exchanger 39 that are disposed in series so that the same flow of air passes through them from the inlet 42 to the outlet 33. As a result, the second ventilation means 36 selectively aspirate air from the enclosure, via the inlet 42, and pass it through the evaporator 37, which cools it and condenses its moisture, then through the condenser 38 which heats it, and through the heat exchanger 39 which further heats it and thereafter return it to the enclosure 1 via the outlet 33.

Upstream of the evaporator 37 is an inlet flap 40 with two positions shown in FIGS. 4 and 5, respectively.

In the first position, shown in FIG. 4, also known as the washing position, the inlet flap 40 selectively directs air extracted from the enclosure 1 via the inlet 42 to the external atmosphere via the main outlet 35. At the same time, the second ventilator means 36 aspirate air from the external atmosphere through the main inlet 34, and direct it into the interior of the enclosure 1 via the outlet 33.

The inlet flap 40 assumes the second position shown in FIG. 5, during drying steps. In this second position, the main inlet 34 and the main outlet 35 communicate directly and are isolated from the enclosure 1. The second ventilator means 36 aspirate air from inside the enclosure 1 via the inlet 42, cause it to be dried by the evaporator 37 and then heated by the condenser 38 and the heat exchanger 39, and return it into the enclosure 1 via the outlet 33.

When the machine is operating, a method of washing carts and bins may advantageously be executed, is comprising:
a) a washing step during which the washing manifolds 18-21 are fed with washing liquid and the main shuttle assembly 22 and the secondary shuttle assembly 26 are moved vertically to spray jets of washing liquid onto a cart 7 or mobile bin placed in the enclosure 1 during one or more vertical sweeps,
b) a rinsing step, similar to the washing step, but using a rinsing liquid,
c) a drying step, during which the cart 7 or mobile bin is swept with a transverse flat jet of air produced by the main shuttle assembly 22 and which mechanically expels droplets of rinsing liquid present on the cart 7 or mobile bin, and the air in the enclosure 1 is simultaneously dried by the dehumidifier center 30, the temperature of the drying air being from approximately 40° C. to approximately 50° C.

In the embodiment shown, the enclosure 1 is designed to contain a single cart. An enclosure 1 could naturally be designed to contain two carts placed one behind the other. An enclosure 1 could equally be designed comprising an entry passage adapted to be shut off by a first roller shutter, and an exit passage on the opposite side adapted to be shut off by a second roller shutter, constituting a tunnel along which carts are moved unidirectionally from the entry to the exit.

Clearly, the washing manifolds 18-21 are fed with washing or rinsing liquid by flexible pipes that conduct fluids whilst at the same time allowing vertical movement in translation of the main shuttle assembly 22 and the secondary shuttle assembly 26. Similarly, the heater elements 22g of the main shuttle assembly 22, and the motor 22b of the main shuttle assembly 22, are supplied with electrical power by flexible conductors that allow vertical movement of the main shuttle assembly 22.

Thanks to the fact that the second ventilator means 22a and 22b are on the main shuttle assembly 22, the production of the flow of drying air is particularly effective, reliable and inexpensive, and this allows high drying efficiency.

The present invention is not limited to the embodiments that have been described explicitly, but includes variants and generalizations thereof falling within the scope of the following claims.

1. A machine for washing carts and bins, said machine comprising a closed washing enclosure having at least one front access passage with closure means for the entry and exit of at least one cart or bin to be washed, with washing manifolds mobile along at least one side of said washing enclosure to spray a washing liquid toward said cart(s) or bin(s) with a sweeping movement, and with means for producing and projecting toward the cart(s) or bin(s) hot drying air, wherein:
means for producing and projecting hot drying air comprise a main shuttle assembly movable vertically in the vicinity of a wall of said washing enclosure, comprising first ventilation means for aspirating air from said wall to circulate it over heating elements in order to heat it, and for propelling it into appropriate guide ducts that project it in the form of a unidirectional flat jet of air into said washing enclosure, so that said unidirectional flat jet of air mechanically expels droplets of liquid present on the cart(s) or bin(s) during drying steps,
the machine further comprises a dehumidifier center adapted to aspirate air from said washing enclosure, to dry the aspirated air, to heat it, and to return it into said washing enclosure in an independent flow during said drying steps.

2. The washing machine claimed in claim 1, wherein said heating elements of said main shuttle assembly heat said drying air to a temperature from approximately 40° C. to approximately 50° C.

3. The washing machine claimed in claim 1, wherein said main shuttle assembly is disposed along a lateral wall of said washing enclosure and furthermore carries one or more washing manifolds adapted to spray jets of washing liquid transversely into said washing enclosure below ducts for producing said transverse unidirectional flat jet of air.

4. The washing machine claimed in claim 1, comprising a secondary shuttle assembly opposite said main shuttle assembly, movable vertically in front of said main shuttle assembly, and carrying one or more washing manifolds.

5. The washing machine claimed in claim 1, wherein said dehumidifier center comprises second ventilation means for selectively aspirating air from said washing enclosure and passing it through an evaporator that cools said air and condenses its moisture, then through a condenser and through a heat exchanger that heat said air, and then returning it into said washing enclosure.

6. The washing machine claimed in claim 5, wherein said dehumidifier center comprises an inlet flap which, in a first washing position, selectively directs air extracted from the washing enclosure toward the outside atmosphere during washing steps and, in a second drying position, selectively directs air extracted from said washing enclosure to recycle it to said washing enclosure after passing it through said evaporator, said condenser and said heat exchanger during drying steps.

7. The washing machine claimed in claim 6, wherein, during washing steps, said inlet flap in said washing position takes in outside air to direct it into said washing enclosure via said evaporator, said condenser and said heat exchanger which is then inactive.

8. The washing machine claimed in claim 1, wherein said main shuttle assembly and said secondary shuttle assembly are each driven in vertical movement by a respective pulley and a respective traction cable, with a traction cable tension sensor supplying an alarm signal to interrupt the rotation of said pulley in the event of detection of a tension above a particular top threshold or below a particular bottom threshold.

9. The washing machine claimed in claim 1, wherein said main shuttle assembly furthermore carries two transverse horizontal washing manifolds respectively in the vicinity of said access passage and in the vicinity of said opposite rear face of said washing enclosure, said transverse washing manifolds being free to pivot upward about a rotation axis along one of said lateral washing manifolds, in order to remain abutted against a possible obstacle during downward movement of said main shuttle assembly.

10. A method of washing carts and bins using a washing machine as claimed in any of claims 1 to 9, said method comprising the following steps:
a) a washing step during which the washing manifolds are fed with washing liquid and the main shuttle assembly and the secondary shuttle assembly are moved vertically to spray jets of washing liquid onto a cart or mobile bin placed in the enclosure during one or more sweeps,
b) a rinsing step, similar to the washing step, but using a rinsing liquid, and
c) a drying step, during which the cart or mobile bin is swept with a unidirectional transverse flat jet of air which mechanically expels droplets of rinsing liquid present on the cart or mobile bin, and the air in the enclosure is dried by the dehumidifier center, the temperature of the drying air in the transverse flat jet of air being from approximately 40° C. to approximately 50° C.
